(19) United States
(12) Patent Application Publication
(10) Pub. No.: US 2026/0186144 A1
(43) Pub. Date: Jul. 2, 2026

(54) METASURFACE-ENABLED OPTICAL SENSING

(71) Applicant: 2Pi Inc., Cambridge, MA (US)

(72) Inventors: Xiaochen Sun, Chino Hills, CA (US); Tian Gu, Acton, MA (US); Juejun Hu, Newton, MA (US)

(73) Assignee: 2Pi Inc., Cambridge, MA (US)

(21) Appl. No.: 19/435,642

(22) Filed: Dec. 29, 2025

Related U.S. Application Data
(60) Provisional application No. 63/739,543, filed on Dec. 28, 2024.

(51) Int. Cl. G01S 17/89; B82Y 20/00; G01S 7/481; G02B 1/00

(52) U.S. Cl. CPC G01S 17/89; B82Y 20/00; G01S 7/4812; G01S 7/4813; G01S 7/4814; G01S 7/4816; G02B 1/002

(57) ABSTRACT

A sensor system which integrates metasurface-enabled optical sensing and illumination functionalities for tactile sensing via a sensing interface. The sensor system includes an illumination module including a light source and flat optics for projecting an illumination light (e.g. a pattern) toward the sensing interface, and an imaging module including flat optics and photodetectors for receiving the illumination light reflected or scattered by the sensing interface and capturing related optical signals including images. The captured optical signals are analyzed to detect interactions of an external object with the sensing interface. The disclosed system allows high performance characteristics, including ultra-wide fields of view, high-resolution imaging, and a significantly reduced form factor compared to traditional optical systems.

### BACKGROUND OF THE INVENTION

This invention relates to metasurface optics systems, and in particular, it relates to metasurface optics systems, architectures, and methods for optical sensing applications.

Tactile sensing is the ability to perceive and measure physical interactions, such as touch, pressure, or texture, through a sensing interface. It is essential for enabling precise interaction and feedback in applications like robotics, AR/VR, and human-machine interfaces. Tactile sensors detect and process these interactions to provide spatial and material information, replicating the sense of touch for enhanced functionality and control in a wide range of systems. Existing tactile sensing techniques typically rely on mechanical, electrical, or optical systems to detect touch and pressure. Mechanical methods use deformation of materials to gauge force, while electrical techniques utilize resistive, capacitive, or piezoelectric sensors for touch detection. Optical methods employ light-based interactions such as imaging to capture surface or contact data. While optical approaches can in theory offer high precision tactile sensing, these systems are typically bulky and composed of multiple discrete optical components, resulting in limited imaging quality, field of view, as well as complicated assembly processes.

### SUMMARY OF THE INVENTION

Embodiments of the present invention provide a novel approach to tactile sensing using metasurface optics, which overcomes the limitations of current optical tactile sensors while unlocking new functionalities. Unlike traditional designs, the metasurface architectures harness the planar and ultra-thin properties of metasurfaces to enable highly compact and integrated systems. These metasurfaces allow for precise wavefront manipulation, allowing illumination and imaging functions integrated within compact optical modules. This integration not only simplifies system assembly but also reduces size, weight, and power consumption, making the technology ideal for applications requiring compact and high-performance tactile sensing.

The metasurface-based tactile sensing systems according to embodiments of the present invention achieve exceptional performance through a combination of wide field-of-view imaging, high resolution, and multi-modal sensing capabilities within a compact form factor. By co-designing the emitter and imager, the system supports advanced functionalities, such as detecting deformed and non-deformed surface geometries, depth, and analyzing material properties through polarization or wavelength-specific responses. This innovative approach enables a new generation of tactile sensors that are ultra-compact, multifunctional, and capable of addressing the diverse needs of modern applications, from robotics to augmented reality and beyond. In addition to tactile sensing, embodiments of the invention may be generally used for optical sensing via an interface.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve the above objects, the present invention provides a sensor system, which includes: a sensing interface configured to interact with an external object; an illumination module including a light source and first flat optics, configured to generate an illumination light and direct the illumination light toward the sensing interface; and an imaging module including second flat optics and a plurality of photodetectors, configured to receive the illumination light reflected or scattered by the sensing interface and to capture optical signals related to the sensing interface.

In some embodiments, the illumination module is configured to project illumination patterns onto the sensing interface, the patterns including one or more of grids, dots, and lines.

In some embodiments, the illumination module is configured to generate illumination light with a field-of-view of at least 90°, and the imaging module is configured to receive reflected or scattered illumination light with a field-of-view of at least 90°.

In some embodiments, the first and second flat optics are configured to operate at a range of wavelengths that includes visible range or infrared range or both, and are configured to operate at a single wavelength, or multiple wavelengths, or over a continuous wavelength range.

In some embodiments, the first and second flat optics are multiplexed into a single flat-optics element, wherein same areas of the single flat-optics element are configured to perform both illumination and imaging functions.

In some embodiments, the sensing interface is made of a polymer, glass, or fabric material, and is rigid, or flexible, or deformable, or stretchable.

In some embodiments, the sensing interface is flat, or curved, or conformally integrated on a support component, and wherein one or both sides of the sensing interface is flat or curved.

In some embodiments, the sensing interface includes a light guide configured to direct and contain the illumination light within it by total internal reflection or by reflective coatings formed on surfaces of the light guide.

In some embodiments, the sensor system further includes an optical component which is attached to the sensing interface, or formed as a separate layer and assembled with the sensing interface, or conformally coated directly onto the sensing interface, configured to cooperate with the sensing interface by modulating, reshaping, collimating, or focusing the illumination light.

In some embodiments, the optical component includes multi-layer metasurfaces or hybrid structures combining diffractive elements or coatings, configured to perform polarization control or wavelength-specific filtering.

In some embodiments, the light source includes a plurality of light emitters, wherein the plurality of light emitters and the plurality of photodetectors form a coaxial configuration.

In some embodiments, the illumination module is further configured to generate a reference beam directed toward the plurality of photodetectors.

In some embodiments, the illumination module and the imaging module further include one or more of spacers, apertures, filters, and lenses.

In some embodiments, the sensor system further includes a data processing system electrically coupled to the imaging module.

In another aspect, the present invention provides a method of using the above sensor system, the method including: by the illumination module, projecting an illumination light toward the sensing interface; by the imaging module, capturing optical signals of reflected or scattered illumination light from the sensing interface; by the data processing system, analyzing the captured optical signals to detect interactions of the sensing interface with an object.

In some embodiments, the method further includes: by the data processing system, analyzing the captured optical signals to detect material properties or surface features of the object through polarization and wavelength-specific responses.

In some embodiments, the method further includes: by the illumination module, generating a refence light which is mutually coherent with the illumination light, and directing the refence light toward the imaging module; by the imaging module, detecting the reference light; and comparing captured reflected or scattered illumination light with the detected reference light to extract phase-sensitive information of the reflected or scattered illumination light.

In another aspect, the present invention provides a sensor system, which includes: a sensing interface configured to interact with an external object; a metasurface optical element; a plurality of light emitters optically coupled to the metasurface optical element and configured to generate illumination light directed toward the sensing interface; and a plurality of photodetectors optically coupled to the metasurface optical element and configured to receive light reflected or scattered by the sensing interface, wherein the metasurface optical element is configured to perform optical functions for both illumination and detection, and wherein optical signals captured by the photodetectors are processed to determine information related to interaction of the external object with the sensing interface.

In some embodiments, the metasurface optical element includes a plurality of meta-atoms configured to manipulate one or more of phase, amplitude, polarization, or wavelength of light.

In some embodiments, the metasurface optical element is configured to perform different optical functions for the illumination light and for the light received from the sensing interface based on one or more of wavelength, polarization, or angle of incidence.

In some embodiments, the sensing interface is rigid, flexible, deformable, or stretchable.

In some embodiments, the sensing interface includes a polymer, glass, fabric, or elastomer material.

In another aspect, the present invention provides a sensor system, which includes: a sensing interface configured to interact with an external object; and a plurality of pixels, each pixel including: a light emitter configured to generate illumination light, a photodetector, and a metasurface region optically coupled to both the light emitter and the photodetector, wherein the metasurface region is configured to direct the illumination light from the light emitter toward the sensing interface and to direct light returned from the sensing interface toward the photodetector; and wherein the photodetector detects interference between a reference optical field that is mutually coherent with the illumination light and light reflected or scattered by the sensing interface to extract phase-sensitive information.

In some embodiments, the reference optical field is derived from the illumination light by splitting or redirecting a portion of the illumination light prior to interaction with the sensing interface.

In some embodiments, the reference optical field propagates along an internal optical path that is free of interaction with the sensing interface or the external object.

In some embodiments, the reference optical field and the reflected or scattered light propagate through a common region of the metasurface region along a shared optical axis.

In some embodiments, the phase-sensitive information corresponds to one or more of surface deformation, displacement, vibration, curvature, thickness variation, or refractive index variation.

In some embodiments, the plurality of pixels are arranged in an array and fabricated using wafer-level processes.

In another aspect, the present invention provides a sensor system, which includes: a sensing interface; a light source configured to generate illumination light; flat optics configured to: direct a first portion of the illumination light toward the sensing interface, and direct a second portion of the illumination light along an internal optical path to form a reference beam; and one or more photodetectors configured to receive both the reference beam and light reflected or scattered by the sensing interface, wherein the reference beam and the reflected or scattered light are mutually coherent and interfere at or near the one or more photodetectors, and wherein phase differences between the reference beam and the reflected or scattered light are used to determine one or more physical characteristics of the sensing interface or the external object.

In some embodiments, the flat optics include a metasurface configured to generate both the illumination light and the reference beam.

In some embodiments, the reference beam is routed through an internal structure, surface, or optical path within a substrate or optical assembly of the sensor system.

In some embodiments, interference between the reference beam and the reflected or scattered light converts optical phase differences into measurable intensity variations at the photodetectors.

In another aspect, the present invention provides a method of optical sensing, which includes: illuminating a sensing interface using light emitted through flat optics including a metasurface optical element; generating a reference optical field that is mutually coherent with the illumination light; receiving, at one or more photodetectors, both the reference optical field and light reflected or scattered by the sensing interface through the flat optics; and extracting phase-sensitive information by comparing the reference optical field with the reflected or scattered light, wherein the extracted phase-sensitive information corresponds to interaction of an external object with the sensing interface.

In some embodiments, extracting phase-sensitive information includes converting optical phase differences into intensity variations via interference at or near the photodetectors.

In some embodiments, the method further includes determining one or more of surface topography, deformation magnitude, depth, texture, or dynamic motion of the sensing interface or the external object.

In some embodiments, the method further includes analyzing the phase-sensitive information using a data processing system including a neural network.

It is to be understood that both the foregoing general description and the following detailed description are exemplary and explanatory and are intended to provide further explanation of the invention as claimed.

### BRIEF DESCRIPTION OF DRAWINGS

FIG. 1 schematically illustrates a sensor system including meta-optics-based imager/illuminators and a sensing interface, according to an embodiment of the present invention.

FIG. 1A schematically illustrates a sensor system according to another embodiment of the present invention.

FIG. 1B schematically illustrates a sensor system according to another embodiment of the present invention.

FIGS. 2A and 2B schematically illustrate an exemplary meta-optics design showing high-resolution, wide-FOV imaging or light projection from/to the sensing interface, respectively.

FIG. 3 schematically illustrates a sensor system including meta-optics-based imager and a sensing interface coupled with a light source or an illumination module according to another embodiment of the present invention.

FIGS. 4A and 4B schematically illustrate a sensor system with a secondary metasurface or optical component cooperating with the sensing interface according to other embodiments of the present invention.

FIG. 5 schematically illustrates a sensor system including meta-optics-based imager/illuminators and a sensing interface, according to another embodiment of the present invention.

FIG. 6 schematically illustrates a sensor system and related control components according to embodiments of the present invention.

FIG. 7 schematically illustrates a method of using the sensing system according to embodiments of the present invention.

### DETAILED DESCRIPTION OF THE INVENTION

Embodiments of the present invention provide novel approaches to sensing via an interface (e.g., tactile sensing) by integrating metasurface-enabled optical sensing and illumination functionalities. The disclosed system allows high performance characteristics, including ultra-wide fields of view, high-resolution imaging, and a significantly reduced form factor compared to traditional optical systems. This innovation addresses critical limitations of conventional approaches, enabling scalable, high-precision, and multi-functional tactile sensing solutions for diverse applications.

Optical metasurfaces are engineered artificial media consisting of 2D arrays of subwavelength structures known as meta-atoms. These meta-atoms are positioned on a substrate and can be fabricated from the same or different optical materials as the substrate. The meta-atoms are specifically designed to manipulate incident light by altering its phase, amplitude, and polarization. Optical metasurfaces have quickly become a transformative technology in the field of optics, offering compact, flat optics with significant improvements in performance while reducing the size, weight, power, and cost (SWaP-C) of traditional optical systems. In addition to metasurface optics, other flat optics may also be utilized. Flat optics may generally refer to metasurfaces, multilayer metasurfaces, diffractive optical elements (DOEs), holographic optical elements (HOEs), wafer-level optics (WLO), micro-optics, hybrid optics (e.g., metasurface combined with other optical components), coatings, etc.

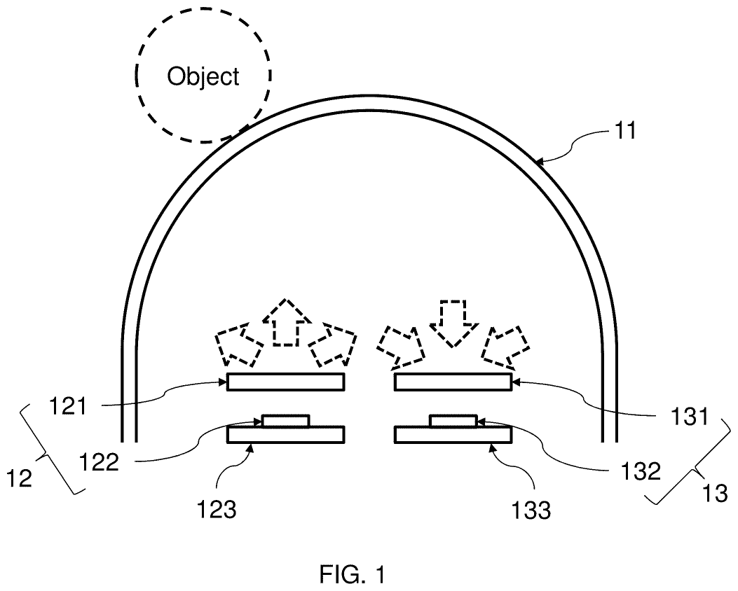

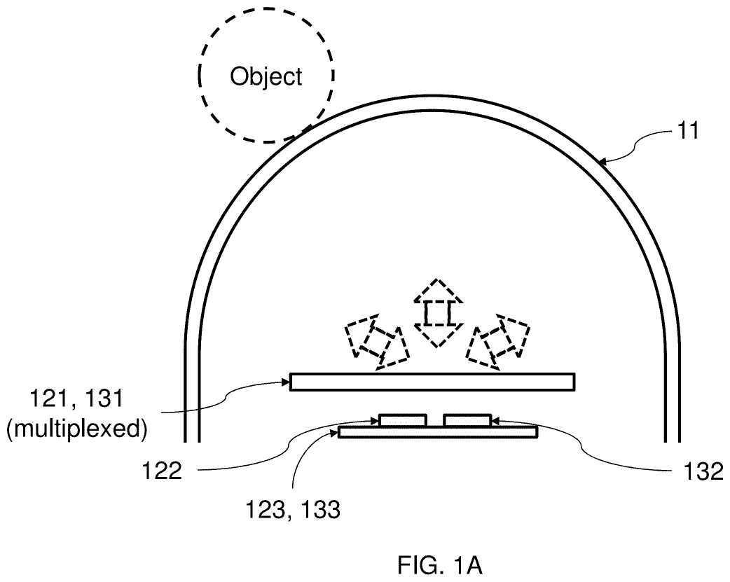

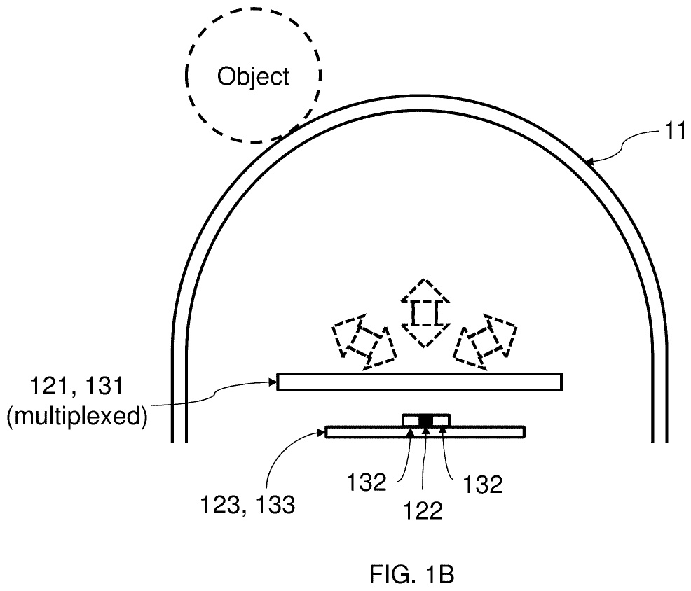

FIG. 1 schematically illustrates a sensor system according to an embodiment of the present invention. The sensor system includes a sensing interface 11, an imaging module 13, and an illumination module 12. During operation, the illumination module 12 directs light towards the sensing interface 11 and/or an external interacting object. When the object engages with the interface 11—with or without physical contact, via interactions such as proximity, or various physical effects such as mechanical, optical, chemical, electrical or magnetic effects—the imaging module 13 captures optical signals including images corresponding to these events. These captured signals can then be analyzed to extract detailed information about the object, including its spatial information, geometry, depth, material properties, or interaction dynamics. The imaging module 13 may capture the information in several ways: by directly imaging the object itself, recording the interaction at the interface 11, analyzing modified light patterns projected onto the interface or object by the illumination module, or a combination of such functions. The imaging module 13 is versatile and may function independently of the illumination module 12 in certain configurations, further enhancing the system's flexibility and adaptability for diverse applications.

The illumination module 12 incorporates advanced illumination meta-optics (flat optics) 121 (e.g., metalenses, pattern generator, beam splitter, diffuser, etc.) and light emitters 122, including VCSELs, LEDs, or similar sources, disposed on a substrate or support structure 123. This module is designed to project various illumination patterns onto the sensing interface 11, which can include a wide range of 2D or 3D patterns such as arrays of dots, lines, matrices, letters, graphics, holograms, random or gray-scale patterns, uniform or diffusive distributions, and more. These versatile light projections enable the illumination module 12 to function effectively in roles such as projectors, illuminators, or diffusers. Additionally, the illumination module 12 is capable of achieving a wide range of illumination field-of-views (FOV), for example, from 1°, extending up to 180°, or more preferably, from 90° to 180°, ensuring comprehensive coverage and adaptability for diverse applications.

The imaging module 13 includes imaging meta-optics 131 (flat optics) (e.g., a metalens) and an array of photodetectors 132 (e.g., CMOS image sensors), disposed on a substrate or support structure 133. These imaging meta-optics are designed to precisely capture images or other optical signals related to the sensing interface and interactions occurring on or near it. With a similarly wide range of field-of-views, e.g., from 1° to 180°, or more preferably, from 90° to 180°, the imaging module 13 ensures high-resolution, wide-angle coverage, making it ideal for capturing detailed data over large or complex areas. Together, these modules create a cohesive system capable of delivering exceptional performance in both illumination and imaging functions.

The meta-optics 121, 131 for illumination and imaging functions may be formed on separate substrates, or integrated on the same substrate, reducing system complexity while improving alignment precision and manufacturability. A single meta-optics element may be engineered such that the same areas of the meta-optics perform both illumination and imaging functions through multiplexing techniques and provide different functions depending on the property of light (e.g., wavelength, polarization, incident angle, etc.). For example, the metasurface designs may include polarization multiplexing or wavelength-specific functionalities to independently tailor to the emitted and detected light, further enhancing the system's performance and versatility. For example, the metasurface can be designed to project specific wavelengths or polarization states for certain illumination patterns while simultaneously focusing or redirecting light signals for imaging.

In embodiments that use a multiplexed meta-optics element, the light emitters and photodetectors may be arranged in various configurations behind the meta-optics element. In some embodiments, the light emitters and photodetectors are disposed on separate substrates or separate areas of a common substrate and are optically aligned with the meta-optics element (see FIG. 1A). In other embodiments, the light emitters and photodetectors are integrated on a common substrate, for example in an interleaved, tiled, coaxial, or pixel-level arrangement (see FIG. 1B). The meta-optics element may perform the same or different optical functions for emitted and received light via multiplexing based on wavelength, polarization, angle of incidence, or a combination thereof.

The sensing interface 11 may be made of polymer, glass, fabric, etc., or any materials whose interaction with the object can be optically captured by the imaging module. The sensing interface may be flat, curved or conformally integrated on another support component. One or both sides of the sensing interface may be flat or curved. The sensing interface may be rigid, flexible, deformable, or stretchable. In preferred embodiments, the sensing interface 11 is located in close proximity with the illumination module 12 and the imaging module 13, e.g., 0.1 to 100 mm, but the invention is not limited to such embodiments.

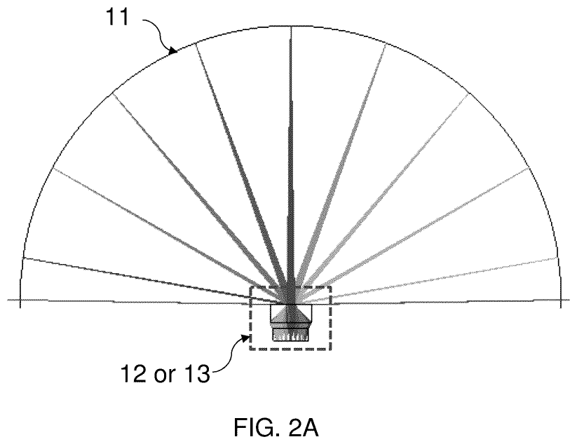

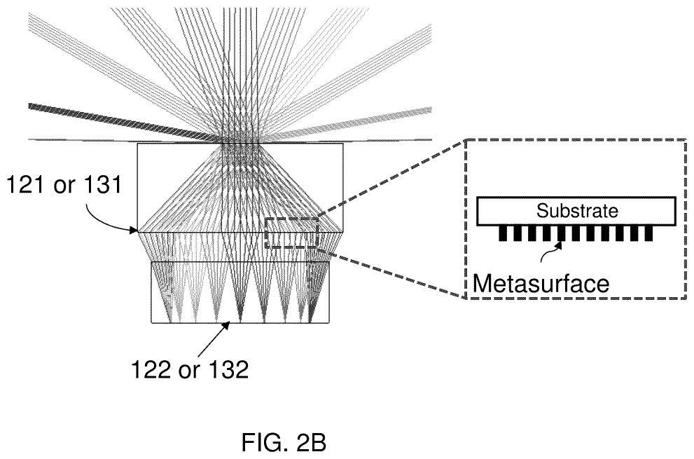

FIGS. 2A and 2B illustrate an exemplary meta-optics design along with simulation results, showcasing its versatility for use in either the imaging or illumination module. FIG. 2B shows details of the structure in the dashed-line box of FIG. 2A and simulation results. This meta-optics configuration enables high-resolution, wide-angle performance, achieving fields of view up to 180°, whether capturing detailed images on photodetectors or projecting light patterns from light emitter arrays. The meta-optics may be configured to operate at a wide range of wavelengths (e.g., from the visible to the infrared (IR)). The meta-optics may be designed to operate at a single wavelength, multiple wavelengths, or over a continuous spectral range. Additional optical components such as spacers, apertures, filters, lenses, may be included in the configuration.

Such additional optical components may be disposed at various locations within the optical path of the sensing system. For example, one or more spacers may be positioned between the flat optics and the light emitters or photodetectors to define optical spacing, focal distance, or alignment tolerance. One or more apertures may be disposed in front of, behind, or integrated with the flat optics to limit numerical aperture, suppress stray light, or improve contrast. One or more optical filters, including wavelength-selective, polarization-selective, or bandpass filters, may be positioned between the flat optics and the photodetectors or the light emitters, or integrated with the flat optics or the sensing interface, to selectively transmit or block portions of the optical spectrum. Additional lenses or optical elements may be placed upstream or downstream of the flat optics to further shape, relay, or condition the illumination or imaging light. These components may be discrete elements, integrated structures, or formed as part of a wafer-level optical assembly, and may be used individually or in combination depending on application requirements.

In one embodiment, the sensing interface 11 is composed of a deformable material, such as an elastomer, which allows it to adapt dynamically to the shape and pressure of objects in contact with it. When an object interacts with the sensing interface, the material deforms, creating a topographical imprint that reflects the object's geometry and interaction dynamics. This deformation alters the optical properties of the interface, such as the way light is transmitted, reflected, or scattered.

The imaging module 13 captures these changes in one or more ways: by directly imaging the object itself, recording the deformed interface, analyzing modified light patterns projected onto the interface or object by the illumination module, or a combination of such functions via multiplexing. The illumination module 12 can project tailored light patterns, such as grids, dots, or lines, that are altered by the deformation of the sensing interface 11, enhancing the system's ability to extract precise details about the object's shape, size, and surface texture. This approach enables the sensor to provide high-resolution, three-dimensional information about contact events, making it highly suitable for applications requiring detailed tactile feedback.

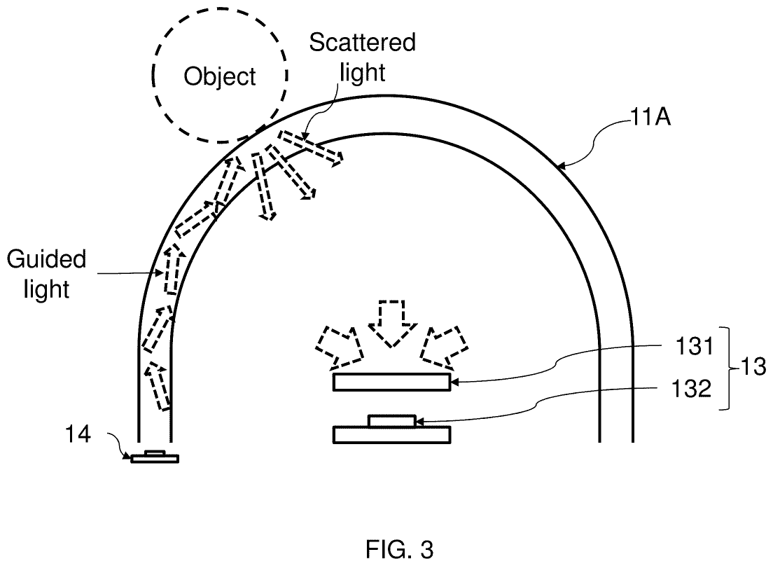

In another embodiment, the sensing interface 11A incorporates a light guide, such as an optical medium with a suitable thickness, which is designed to direct and contain light beams within its structure. As illustrated in FIG. 3, the light guide 11A is illuminated by a light source 14, which may be a standalone emitter or part of an advanced illumination module integrating meta-optics and light emitters such as LEDs or VCSELs. The illumination light is guided within the light guide 11A through mechanisms such as total internal reflection (TIR) or via reflective coatings applied to the light guide's surfaces.

When an object comes into contact with the sensing interface 11A, the TIR condition at the point of contact is disrupted, causing the light to scatter. This scattering occurs at or near the contact location and alters the light distribution within the light guide. The imaging module 13, equipped with high-resolution meta-optics and photodetectors, captures these scattered light signals, enabling the system to precisely determine the position, size, and interaction characteristics of the contact point. The light guide 11A itself can be made from various materials, such as polymers, glass, or hybrid composites, and can be rigid or flexible depending on the application requirements.

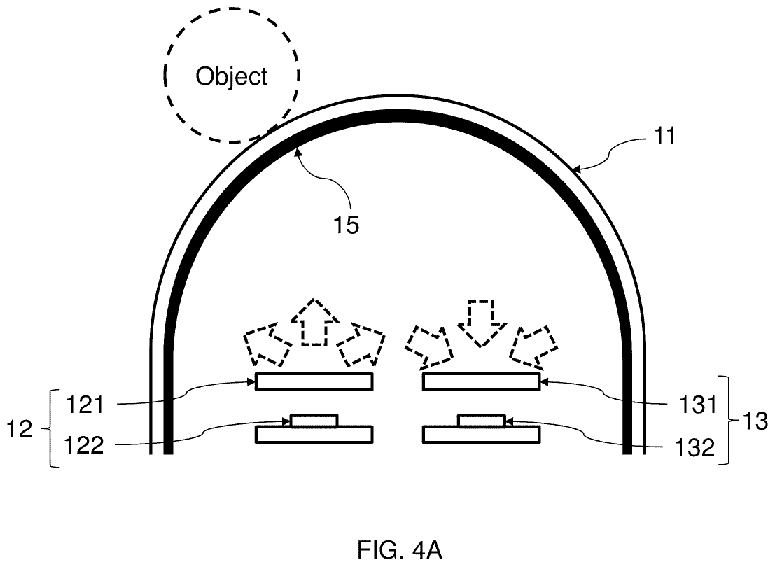

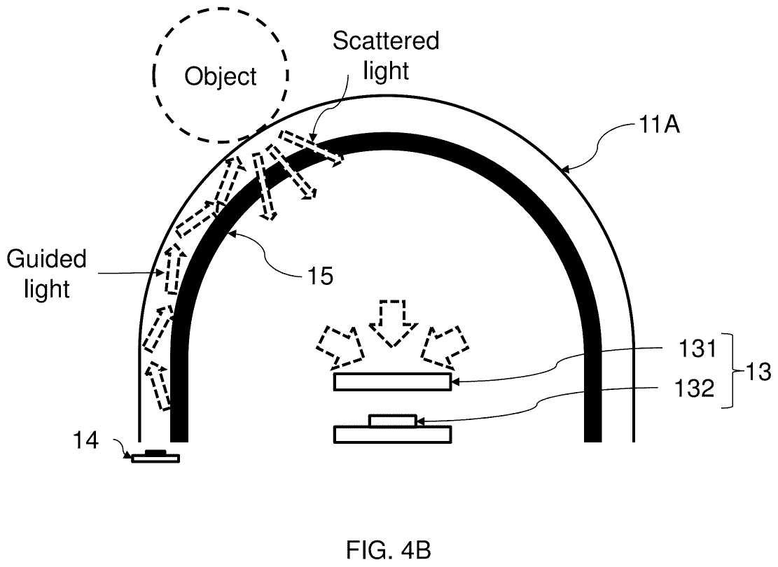

In yet another embodiment, an additional optical component 15 may be provided which cooperates with the sensing interface 11 to enhance its functionality by further modulating or shaping the light. This additional optical element 15 may be designed to optimize light interactions and improve the system's overall performance for specific applications. For instance, as illustrated in FIG. 4A, a secondary metasurface 15 (flat or curved) may be attached to the sensing interface, formed as a separate layer and assembled with the sensing interface, or conformally coated directly onto the sensing interface. This metasurface 15 can provide advanced optical functions such as modulating, reshaping, collimating, or focusing the light to achieve the desired optical behavior. For example, a meta-optics may be designed to concentrate light at specific regions or direct light towards certain directions, enhancing the sensitivity of the imaging module to detect fine details. Similarly, a reshaping metasurface may modify light patterns to match the unique geometries of the sensing interface, ensuring uniform illumination or optimized signal capture. These additional optical components may also include multi-layer metasurfaces or hybrid structures, combining diffractive elements, coatings, or other advanced materials to achieve multi-functional capabilities, such as polarization control or wavelength-specific filtering.

FIG. 4B illustrates an embodiment that includes both a light guide 11A (e.g. similar to that shown in FIG. 3) and an additional optical component 15 (e.g. similar to that shown in FIG. 4A).

In addition to detecting deformed and non-deformed surface geometries, embodiments of the present invention based on optical metasurfaces can further analyze material properties of the object through polarization and wavelength-specific responses. Metasurfaces can be designed to sense and/or manipulate the polarization state of light with high precision, enabling the detection of subtle changes in surface topography or material characteristics. For example, when light interacts with a surface, the altered polarization states can be captured and analyzed by the imaging module, providing detailed information about the surface geometry. Similarly, polarization-based sensing can differentiate between materials with distinct birefringence or polarization response characteristics, further enhancing the sensor's versatility.

In addition to polarization, the metasurface-based tactile sensor may also exploit wavelength-specific responses to extract detailed material properties and detect surface features of the object. The metasurfaces can be engineered to operate across a broad spectral range, from visible to infrared wavelengths, allowing the system to perform multi-spectral analysis. This capability enables the sensor to identify materials based on their spectral absorption, reflection, or scattering profiles, which are unique to each material. Furthermore, by incorporating wavelength-selective designs, the metasurface system can optimize sensitivity and resolution for specific applications, such as detecting fine surface features or monitoring dynamic material interactions. Together, these advanced functionalities make the metasurface tactile sensor a powerful tool for multi-modal, high-precision tactile sensing in diverse applications.

Embodiments of the present invention can further leverage image post-processing to reconstruct information captured by the optical sensing system, enabling highly accurate and efficient data processing. For example, neural networks can be employed to analyze the optical signals including images obtained from the metasurface-based sensing and illumination modules, extracting complex patterns and correlations that traditional algorithms may struggle to identify. For instance, the neural network can interpret deformation patterns on the sensing interface or scattered light signals from an object to reconstruct detailed spatial and material information, such as topography, texture, or interaction dynamics. By training the neural network on a diverse dataset of optical responses, the system can learn to generalize across various object types, materials, and environmental conditions, enhancing its adaptability and precision.

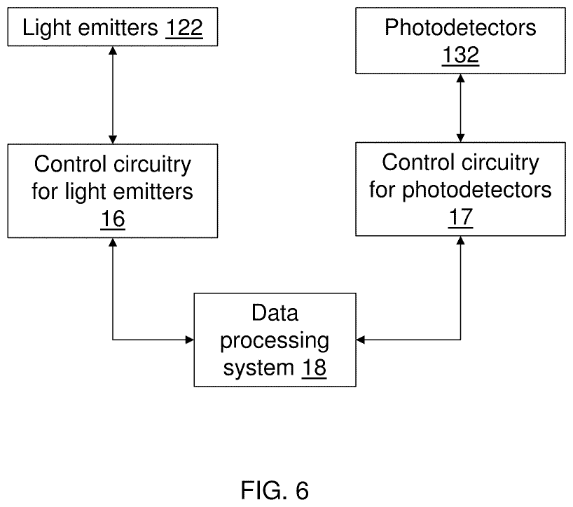

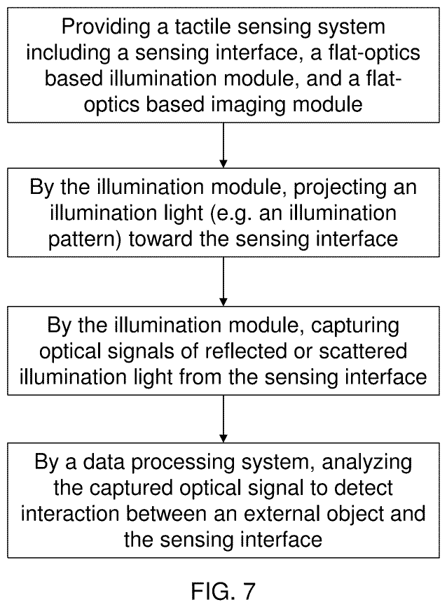

As schematically illustrated in FIG. 6, the light emitters 122 and the photodetectors 132 are electrically coupled to suitable electrical circuits 16, 17 and further to a data processing system 18 such as one or more processors and/or computers to perform the above-described data processing functions. The method of using the tactile sensing system is summarized in FIG. 7.

In yet another embodiment, the sensor system includes a coaxial configuration of sensors, where the emitter and receiver functionalities coincide within each pixel (see, e.g., FIG. 1B). Each pixel includes a light emitter, a photodetector, and a metasurface region optically coupled to both the light emitter and the photodetector. The plurality of pixels are arranged in an array and may be fabricated using wafer-level processes. This design enables integrated emitter-receiver operation, facilitating advanced optical schemes such as coherent detection. The metasurface optics within this system may be further engineered to enable different manipulation of light for emission and detection. For example, the metasurface can shape the emitted beam into desired patterns while focusing the received light onto the photodetector, by utilizing meta-atoms multiplexing different optical functions depending on the property of light (e.g., polarization, wavelength, angle-of-incident, etc.).

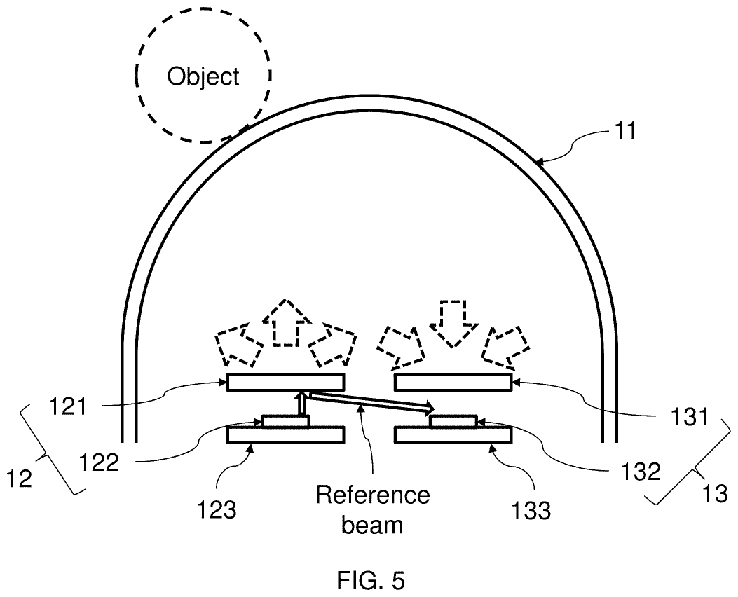

In yet another embodiment, the sensor system may be configured to extract phase-sensitive information by comparing the reflected or scattered light with a reference light beam (or reference optical field). This approach significantly enhances sensitivity, enabling the detection of subtle surface deformations, texture, or material properties. By eliminating the need for separate optical paths for illumination and detection, the coaxial pixel configuration reduces system complexity, improves compactness, and minimizes potential optical aberrations. In some embodiments, schematically illustrated in FIG. 5, the reference beam is derived from the same light source as the illumination light and redirected to the photodetector, such that the reference beam and the reflected or scattered light are mutually coherent. The reference beam may be generated by splitting a portion of the emitted light, routing light through an internal optical path within the optical system or substrate, or by using the flat optics to generate a reference optical field that does not interact with the sensing interface or the external object. The reference beam may propagate along a path that is coaxial or substantially coaxial with the illumination and detection path, or along a closely coupled optical path that maintains phase coherence with the reflected or scattered light.

The reflected or scattered light returning from the sensing interface or object and the reference beam may be combined at or near the photodetector, where interference between the two optical fields converts phase differences into measurable intensity variations. Such phase differences may arise from optical path length changes caused by surface deformation, displacement, vibration, curvature, or thickness variations of the sensing interface, as well as refractive index variations or material-dependent interactions with the object. In some embodiments, the phase-sensitive signals may be analyzed to extract quantitative information related to depth, surface topography, deformation magnitude, dynamic motion, texture, or material properties.

In some embodiments, the reference beam is generated internally within the sensor system and does not interact with the sensing interface or the external object. The reference beam may be derived from the same light source as the illumination light by splitting or redirecting a portion of the emitted light prior to interaction with the sensing interface. In some embodiments, the flat optics are configured to generate both an illumination optical field directed toward the sensing interface and a reference optical field directed toward the photodetector. In other embodiments, the reference beam may be reflected or routed from a known internal structure, surface, or optical path within the metasurface optical system, substrate, or optical assembly that provides a stable and known optical path length. In all such embodiments, the reference beam propagates along an internal optical path that remains phase-stable relative to the reflected or scattered light, thereby enabling phase-sensitive detection.

In the coaxial pixel configuration, the reference beam and the reflected or scattered light may propagate through the same region of the flat optics and share a common optical axis, thereby improving phase stability and reducing sensitivity to misalignment, environmental disturbances, and optical aberrations. By performing illumination, reference generation, and detection within a shared pixel-level optical path, the system enables compact, phase-sensitive sensing architectures without requiring discrete interferometers or separate optical paths, while maintaining high sensitivity and scalability for array-based implementations.

### Additional Information

The meta-atoms may have the same or different geometries, dimensions, and orientations. Their geometries may include, but not limited to, rectangular, elliptical, cylindrical, pillars, ridges, crossings, freeform shapes, any other suitable geometries or combinations of different structures. The arrangement can be periodic (e.g., square, rectangular, hexagonal lattice) or aperiodic (randomized or varying distances between meta-atoms). They may be formed from the same or different materials and may be immersed or encapsulated in another medium. Different regions of the metasurface may have different height. In some examples, the gap between adjacent meta-atoms may be designed to have a constant gap distance.

Exemplary metasurface materials include, but are not limited to, dielectric materials (e.g., silicon, silicon nitride, titanium dioxide, niobium oxide, gallium nitride, chalcogenide glasses, etc.), polymers and organic materials (e.g., polymethyl methacrylate, polydimethylsiloxane, etc.), metals (e.g., gold, silver, aluminum, copper, etc.), semiconductors (e.g., silicon, silicon carbide, gallium arsenide, indium phosphide, etc.), transparent conducting oxides (e.g., indium tin oxide, fluorine-dope tin oxide, etc.), phase change materials (e.g., vanadium oxide, germanium antimony tellurium related alloys, etc.), two dimensional materials (e.g., graphene, molybdenum disulfide, etc.), ceramics (e.g., barium titanate, zirconia, etc.), coatings, metamaterials, etc. Exemplary substrate materials include, but are not limited to, silicon, glass, sapphire, polymers, quartz, alumina, polyimide, polyethylene terephthalate, ceramics, semiconductors, etc. The flat optics and substrate may be made of the same or different materials.

The metasurface may be flat, curved or conformally integrated with the substrate. One or both sides of the substrate may be flat or curved. Both the flat optics and the substrate may be rigid, flexible, or stretchable.

It will be apparent to those skilled in the art that various modification and variations can be made in the sensor system and related method of the present invention without departing from the spirit or scope of the invention. Thus, it is intended that the present invention cover modifications and variations that come within the scope of the appended claims and their equivalents.

1. A sensor system, comprising:
a sensing interface configured to interact with an external object;
an illumination module including a light source and first flat optics, configured to generate an illumination light and direct the illumination light toward the sensing interface; and
an imaging module including second flat optics and a plurality of photodetectors, configured to receive the illumination light reflected or scattered by the sensing interface and to capture optical signals related to the sensing interface.

2. The sensor system of claim 1, wherein the illumination module is configured to project illumination patterns onto the sensing interface, the patterns including one or more of grids, dots, and lines.

3. The sensor system of claim 1, wherein the illumination module is configured to generate illumination light with a field-of-view of at least 90°, and the imaging module is configured to receive reflected or scattered illumination light with a field-of-view of at least 90°.

4. The sensor system of claim 1, wherein the first and second flat optics are configured to operate at a range of wavelengths that includes visible range or infrared range or both, and are configured to operate at a single wavelength, or multiple wavelengths, or over a continuous wavelength range.

5. The sensor system of claim 1, wherein the first and second flat optics are multiplexed into a single flat-optics element, wherein same areas of the single flat-optics element are configured to perform both illumination and imaging functions.

6. The sensor system of claim 1, wherein the sensing interface is made of a polymer, glass, or fabric material, and is rigid, or flexible, or deformable, or stretchable.

7. The sensor system of claim 1, wherein the sensing interface is flat, or curved, or conformally integrated on a support component, and wherein one or both sides of the sensing interface is flat or curved.

8. The sensor system of claim 1, wherein the sensing interface includes a light guide configured to direct and contain the illumination light within it by total internal reflection or by reflective coatings formed on surfaces of the light guide.

9. The sensor system of claim 1, further comprising an optical component which is attached to the sensing interface, or formed as a separate layer and assembled with the sensing interface, or conformally coated directly onto the sensing interface, configured to cooperate with the sensing interface by modulating, reshaping, collimating, or focusing the illumination light.

10. The sensor system of claim 1, wherein the optical component includes multi-layer metasurfaces or hybrid structures combining diffractive elements or coatings, configured to perform polarization control or wavelength-specific filtering.

11. The sensor system of claim 1, wherein the light source includes a plurality of light emitters, wherein the plurality of light emitters and the plurality of photodetectors form a coaxial configuration.

12. The sensor system of claim 1, wherein the illumination module is further configured to generate a reference beam directed toward the plurality of photodetectors.

13. The sensor system of claim 1, wherein the illumination module and the imaging module further include one or more of spacers, apertures, filters, and lenses.

14. The sensor system of claim 1, further comprising a data processing system electrically coupled to the imaging module.

15. A method of using the sensor system of claim 11, comprising:
by the illumination module, projecting an illumination light toward the sensing interface;
by the imaging module, capturing optical signals of reflected or scattered illumination light from the sensing interface;
by the data processing system, analyzing the captured optical signals to detect interactions of the sensing interface with an object.

16. The method of claim 15, further comprising:
by the data processing system, analyzing the captured optical signals to detect material properties or surface features of the object through polarization and wavelength-specific responses.

17. The method of claim 15, further comprising:
by the illumination module, generating a refence light which is mutually coherent with the illumination light, and directing the refence light toward the imaging module;
by the imaging module, detecting the reference light; and
comparing captured reflected or scattered illumination light with the detected reference light to extract phase-sensitive information of the reflected or scattered illumination light.

18. A sensor system, comprising:
a sensing interface configured to interact with an external object;
a metasurface optical element;
a plurality of light emitters optically coupled to the metasurface optical element and configured to generate illumination light directed toward the sensing interface; and
a plurality of photodetectors optically coupled to the metasurface optical element and configured to receive light reflected or scattered by the sensing interface,
wherein the metasurface optical element is configured to perform optical functions for both illumination and detection, and
wherein optical signals captured by the photodetectors are processed to determine information related to interaction of the external object with the sensing interface.

19. The sensor system of claim 18, wherein the metasurface optical element includes a plurality of meta-atoms configured to manipulate one or more of phase, amplitude, polarization, or wavelength of light.

20. The sensor system of claim 18, wherein the metasurface optical element is configured to perform different optical functions for the illumination light and for the light received from the sensing interface based on one or more of wavelength, polarization, or angle of incidence.

21. The sensor system of claim 18, wherein the sensing interface is rigid, flexible, deformable, or stretchable.

22. The sensor system of claim 18, wherein the sensing interface includes a polymer, glass, fabric, or elastomer material.

23.-26. (canceled)
